(19) United States
(12) Patent Application Publication
(10) Pub. No.: US 2003/0125493 A1
(43) Pub. Date: Jul. 3, 2003

(54) (Meth)acrylates of oxyalkylated phenolic resins and their use as adhesion promoters

(76) Inventors: Stephen H. Harris, Kennett Square, PA (US); Carmen L. Rodriguez, Gulph Mills, PA (US)

Correspondence Address: Dr. Shao Guo, Lyondell Chemical Company, 3801 West Chester Pike, Newtown Square, PA, 19073, US

(21) Appl. No.: 10/044,167

(22) Filed: Oct. 26, 2001

(51) Int. Cl. C08F 118/02

(52) U.S. Cl. 526/319

(57) ABSTRACT

(Meth)acrylate esters of oxyalkylated aralkylated, multi-ring phenolic hydroxyl-containing compounds may be prepared with relatively low viscosity, and are effective as coating composition additives, in particular as adhesion promoters.

### BACKGROUND OF THE INVENTION

1. Field of the Invention

The present invention pertains to (meth)acrylates of multi-ring, oxyalkylated phenolic polyols and to their use as additives in coatings and other formulations.

2. Background Art

It is known to produce a variety of (meth)acrylate esters having the structural element

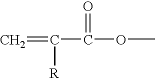

where R is —H or —CH₃, i.e. acrylates and methacrylates. Such compounds are addition polymerizable, and when the molecules contain two or more acrylate moieties, are crosslinkable as well. Bis and tris (meth)acrylates of glycols and polyols such as hexanediol, tripropylene glycol, neopentyl glycol, trimethylolpropane, and glycerine have been used in coatings for many years.

For many applications, it is desired to prepare a very hard coating. However, hardness is often obtained at the expense of adhesion, elongation, and flexibility. It is known to add polyether and polyester di- and triacrylates or to add other acrylate-functional polymers or oligomers to increase adhesion, and particularly, flexibility. However, addition of such oligomeric or polymeric “flexibizer” acrylates dramatically lowers coating hardness, and may also increase the viscosity of the uncured coating formulation to the extent that it is difficult to apply. In many cases, the chemical resistance of such coatings is low as well.

Phenolic acrylates such as p-cresol diacrylate have had little use due to the difficulties in preparing the acrylate esters. Moreover, the phenolic ester linkage is subject to hydrolysis, and thus chemical resistance is compromised. Light stability is also less than desired.

In WO 97/19972, a mono-oxyalkylated phenolic polyol prepared by oxyalkylation with propylene carbonate is reacted with acrylic acid and hexanediol diacrylate in the presence of an esterification catalyst to prepare an acrylate-functional product which also retains substantial unreacted hydroxyl functionality. However, the product is of high viscosity.

It would be desirable to provide an acrylate-functional, phenolic component which can be readily synthesized by conventional techniques, which is chemically resistant, and which may function by itself or with other comonomers as a casting or coating component, producing cross-linked polymers of high hardness, improved adhesion, and good chemical resistance.

### SUMMARY OF THE INVENTION

The present invention pertains to di- and higher (meth)acrylates of oxyalkylated, multi-ring phenolic polyols. These (meth)acrylates may be readily synthesized by conventional esterification techniques, and may function as the sole unsaturated monomer or as a comonomer in casting and coating formulations. Formulations employing the novel (meth)acrylates exhibit high, and in some cases, elevated hardness, while improving adhesion and flexibility. The cured products also exhibit high chemical resistance.

### DETAILED DESCRIPTION OF THE PREFERRED EMBODIMENT(S)

The subject invention (meth)acrylates are derived by esterifying a multi-ring, aralkylated, di- or polyhydroxyl-functional phenolic compound which has been first oxyalkylated, with an alkacrylic acid. By the term “(meth)acrylate” is meant an ester moiety having the formula

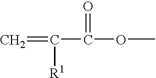

where R¹ is H or CH₃, and thus is an acrylate or methacrylate (i.e., “(meth)acrylate”) moiety.

The multi-ring, aralkylated, oxyalkylated phenolic compounds are prepared by oxyalkylating a multi-ring aralkylated phenolic starter compound. The oxyalkylation may involve from 2 to about 25 mol of alkylene oxide per phenolic hydroxyl group, more preferably 3 to 15 mol of alkylene oxide, and most preferably about 3 to 12 mol of alkylene oxide. The lower limit of alkylene oxide is dictated by the increased number of residual phenolic hydroxyl groups; this number should be preferably about zero, or the stability of the (meth)acrylates may suffer as a result. The upper limit is dictated only by its effect on the final coating or casting. In general, higher levels of oxyalkylation produce a greater softening effect.

The multi-ring phenolic compounds which serve as the starter for the oxyalkylation are multi-ring compounds containing minimally three non-condensed aromatic rings, at least one of which is attached to at least one of the remaining rings through an alkylene bridge, and which itself bears no phenolic hydroxyl groups. The multi-ring phenolic compounds contain, on average, minimally two phenolic hydroxyl groups, preferably from 2 to 10 phenolic hydroxyl groups, and more preferably from 2 to 8 hydroxyl groups. From 2 to 4 hydroxyl groups are especially preferred. In addition to the non-condensed aromatic ring systems, condensed rings such as naphthyl rings may be present. Thus, for purposes of clarity, the starters may include non-condensed aromatic compounds containing at least two phenolic hydroxyl groups and at least three aryl systems, i.e. an aralkylene group, a phenol, and another phenol, or an aralkylene group, a phenol, and a naphthol, the aralkylene, phenol, and naphthol groups linked by direct single bonds or through an alkylene or other bridge as described herein.

The multi-ring aralkylated starter may be prepared by numerous techniques, for example those disclosed in WO 97/19972; U.S. Pat. No. 5,889,137; U.S. Pat. No. 4,241,201; and U.S. Pat. No. 4,167,538, the latter three patents incorporated herein by reference. Preferred multi-ring aralkylated starters include reaction products of phenols or bisphenols with styrene or alkylated styrene such as t-butylstyrene, and optionally with an aryldiolefin coupling agent such as divinylbenzene or divinyl naphthalene, or with an aldehydic coupling agent such as formaldehyde or glyoxal. When coupling agents are used, they become bonded to phenolic hydroxyl-group-containing rings through alkylene bridges, which may contain interspersed aryl groups, O atoms, or N atoms.

Non-limiting examples of aralkylated starters include monostyrenated bisphenol A, monostyrenated bisphenol F, monostyrenated bisphenol S, monostyrenated 4,4′-dihydroxylbiphenyl, monostyrenated 2,2-bis (hydroxynaphthyl)propane, their polystyrenated analogs prepared by styrenating with for example, but not by limitation, from greater than 1 to about 4 moles of styrene per mol of unstyrenated phenol, and other “styrenated” products employing substituted styrenes such as t-butylstyrene. Further examples include coupled products prepared by coupling the above compounds with divinylbenzene, formaldehyde, etc. The coupling may take place prior to, subsequent to, or simultaneous with aralkylation. Preferred aralkylated starters include aralkylated bisphenol A and aralkylated bisphenol A coupled with formaldehyde to provide coupled products with an average functionality higher than 2, preferably in the range of 3 to 6.

The oxyalkylation may be performed with any oxyalkylating agent, including alkylene carbonates. When the latter are employed, they are generally employed in amounts not greater than about 1 mol per mol of phenolic hydroxyl group, and must be followed by oxyalkylation with an oxirane such as ethylene oxide, propylene oxide, or 1,2- or 2,3-butylene oxide, since propylene carbonate does not polymerize under the reaction conditions, and is therefore not capable, alone, of providing products with the necessary degree of oxyalkylation. Examples of suitable alkylene carbonates include, but are not limited to, ethylene carbonate, propylene carbonate, and butylene carbonate. Mixtures of these may be used as well. Suitable catalysts are well known in the art, and include, for example, basic catalysts such as potassium hydroxide.

Preferably, however, the oxyalkylation is performed with one or more alkylene oxides. When two or more alkylene oxides are used, they may be used in admixture or sequentially or any combination thereof. Preferably, the alkylene oxides employed are selected from ethylene oxide, propylene oxide, 1,2- and 2,3-butylene oxide, styrene oxide, and the like. Most preferably, the alkylene oxides are ethylene oxide, propylene oxide, or mixtures thereof, most preferably propylene oxide. Oxyalkylation with alkylene oxides may take place under conventional conditions, with conventional catalysts, for example Lewis acid catalysts, basic catalysts such as potassium hydroxide, and double metal cyanide complex catalysts. Preferred oxyalkylated products are ARYLFLEX®-DS and ARYLFLEX®-MP phenolic polyols available from Lyondell Chemical Co., Houston, Tex.

Following oxyalkylation, the oxyalkylated product is reacted with an alkacrylating agent, preferably the free acid, although esterifyable derivatives such as acryloyl chloride may also be used. By the term “esterifyable alkacrylic acid derivative” is meant just such a derivative. The amount of alkacrylic acid or derivative is adjusted to provide the desired degree of alkacrylation. Preferably, 0.75 to 4 equivalents of alkacrylic acid or more are used per equivalent of hydroxyl group in the oxyalkylated starter.

It is desired that the conversion of hydroxyl groups to (meth)acrylate functionality will be about 70% or more complete, preferably 80% or more, and most preferably, about 90% or more. Perhaps as a result of the relatively high conversion, the product (meth)acrylates are of surprisingly low viscosity, and thus have numerous uses. It is preferable that the liquid, acrylated products have a neat viscosity, measured at 25° C., of less than 3000 cps, preferably less than 2000 cps, and most preferably in the range of 200 cps to 1500 cps. By contrast, the products of WO 97/19972 Example 18 are of high viscosity, 3000 cps at 40% concentration in 1,6-hexanediacrylate, a low viscosity reactive diluent.

The esterification is performed conventionally, i.e. in the presence of an esterification catalyst, preferably an acid catalyst, with removal of water by distillation. Preferably, water is removed azeotropically, for example by employing toluene as a solvent. Following esterification, excess acid is removed along with acid catalyst by suitable purification techniques, for example by washing with water containing a base such as sodium bicarbonate. The product may be used as such, or may be diluted with non-reactive or reactive diluents.

Thus, one aspect of the invention pertains to an (meth)acrylate-functional composition comprising an (meth)acrylate ester of an oxyalkylated, aralkylated multi-ring phenolic polyol prepared by the process of selecting a multi-ring aralkylated phenolic starter having minimally two phenolic hydroxyl groups and at least three non-condensed aryl ring systems; oxyalkylating the aralkylated phenolic starter with from 2 to 25 mol of oxyalkylating agent per equivalent of phenolic hydroxyl groups to produce an oxyalkylated aralkylated phenolic intermediate; and esterifying the oxyalkylated aralkylated phenolic intermediate with an alkacrylic acid or esterifyable derivative thereof to produce an (meth)acrylate ester of said oxyalkylated alkarylated multi-ring phenolic polyol. The step of esterifying is preferably conducted with sufficient alkacrylic acid or esterifyable derivative thereof such that 70 mol percent or more of total hydroxyl groups are esterified. Preferably, the multi-ring aralkylated phenol comprises a reaction product of a bisphenol, an optionally substituted styrene, and optionally, an aryldiolefin or aldehydic coupling agent.

A further aspect of the invention pertains to an addition-curable composition comprising at least one (meth)acrylate-functional composition and a catalyst which promotes the addition polymerization of ethylenically-unsaturated compounds, while a yet further aspect of the invention pertains to the addition-curable composition wherein the catalyst comprises a photoinitiator.

The products are suitable for use alone in coating or casting compositions, and for these purposes may employ conventional free radical initiators such as peroxyesters, peroxyketones, azo compounds, and the like. Such initiators are well known. The compositions may also include photochemical initiators such as Irgacure® 184 available from Ciba Geigy. Numerous other photoinitiators are known and readily available.

The subject products are well suited for use in acrylate compositions in admixture with other acrylates such as 1,6-hexanediol diacrylate, dipropylene glycol diacrylate, trimethylolpropane triacrylate, glycerine triacrylate, and the like. The products of the subject invention may also be used as multi-functional acrylate monomers to prepare other polymerizable species.

For example, the subject invention (meth)acrylates may be oligomerized by reaction with other unsaturated monomers, or by reaction of the remaining relatively small amount of hydroxyl functionality with isocyanate-, carboxylic acid-, or epoxy-functional compounds to provide additional polymerizable species. If the epoxy resin, carboxylic acid or isocyanate-functional compounds are di- or polyfunctional, oligomeric products may be produced.

The subject compounds exhibit unexpectedly excellent utility as adhesion promoters. Such increased adhesion may be useful in preparing coatings on metallic and non-metallic substrates, and also may be useful in castings where adhesion to metal or polymer substrates to produce composite articles is important. Surprisingly, addition of the (meth)acrylates of the present invention to coating compositions may markedly increase adhesion without lowering hardness. In some cases, hardness actually increases. Flexibility may be improved as well. These results are highly unexpected when compared to conventional adhesion promoters.

Having generally described this invention, a further understanding can be obtained by reference to certain specific examples which are provided herein for purposes of illustration only and are not intended to be limiting unless otherwise specified.

### EXAMPLES 1-3

One mole of acrylic acid, 72 g, is introduced into a glass resin kettle together with 150 ml heptane, 5 g methanesulfonic acid, 0.2 g hydroquinone, and 0.5 hydroxyl equivalents of oxypropylated aryl polyol. The latter are ARYLFLEX® DS polyol (237 g, Example 1) and ARYLFLEX® M5P polyol (227 g, Example 2). With an air sparge of 50 ml/min, the resulting solution is refluxed with a Barrett trap for about 8 hours or until the desired condensed water phase is collected. Two volumes of toluene are added, and the solution extracted with sodium carbonate solution to remove residual acid. NMR shows greater than 90% of hydroxy groups have been converted to acrylate esters. The solvent is evaporated in vacuo, leaving acrylated products with viscosities of 596 cps and 1389 cps, respectively.

In a similar manner, a further acrylated polyol (Example 3) was prepared by reacting 198 g ARYLFLEX®-M4P polyol and 72 g acrylic acid in hexane in the presence of 5 g methanesulfonic acid, 1 g hypophosphorous acid, and 0.2 g 4-methoxyphenol. The mixture was refluxed with air sparge until 9-10 ml of water had been collected in the Barrett trap. The product was washed with 20% aqueous NaOH, water, and dried with magnesium sulfate. Solvent was removed at reduced pressure.

### EXAMPLES 4-6 and COMPARATIVE EXAMPLE C1

A urethane acrylate base formulation is prepared from 5 g of a commercial urethane acrylate, SARTOMER® C-981 urethane acrylate (100% solids) available from Sartomer, Exton, Pa., and 2 g tripropylene glycol diacrylate (“TPGDA”). This mixture is stirred until homogenous, and then diluted with a further 3 g TPGDA, and 0.4 g K1P 100F photoinitiator is added to form a UV-curable coating composition for comparative purposes (Comparative Example C1). Coating compositions in accordance with the subject invention are prepared analogously, employing the (meth)acrylates of Examples 1 and 2 and either TPGDA or trimethylolpropane triacrylate (“TMPTA”). The formulations are summarized in Table 1. Coatings are prepared from the comparative and subject invention coating compositions at 3 mil thickness on Bonderite™ 1000 treated steel, and free films are prepared at the same thickness on glass plates. The coatings are cured by four passes by a 300 watt H-type mercury lamp at a 50 ft/min base speed. Coating and film physical characteristics are measured by standard ASTM test methods: Konig hardness (ASTM D4366); Cross-hatch (“Xhatch”) adhesion (ASTM D3359); Front/rear impact (ASTM D2794); Tensile strength and percent elongation (ASTM D638). The results are also presented in Table 1.

TABLE 1

| Example: | C1 | 4 | 5 | 6 |
|---|---|---|---|---|
| Formulation | | | | |
| Example 1 | — | 7 | 7 | — |
| Acrylate | | | | |
| Example 2 | — | — | — | 5 |
| Acrylate | | | | |
| Sartomer ™ | 5 | — | — | — |
| C-981 | | | | |
| TPGDA | 5 | 3 | — | — |
| TMPTA | — | — | 3 | 5 |
| Test Results | | | | |
| Konig Hardness | 93 | 11 | 33 | 12 |
| X-hatch | 0 | 90 | 60 | 0 |
| Adhesion | | | | |
| Impact | 80/40 | 90/<20 | 30/20 | <20/<20 |
| Front/Rev | | | | |
| Tensile | 5099 | 417 | 2433 | 739 |
| Strength | | | | |
| Elongation (%) | 9 | 11 | 11 | 17 |

The results indicate that coatings employing the acrylates of Examples 1 are softer but exhibit much greater adhesion. The coatings employing the acrylate of Example 2 exhibit higher elongation, but are not improved in adhesion. These formulations are not optimized.

### EXAMPLES 7-9 and COMPARATIVE EXAMPLE C2

A hard coating is prepared from a mixture of Sartomer® 104C75, an epoxyacrylate diluted with TMPTA (Comparative Example C2), and TPGDA. In Examples 7-9, the TPGDA of Comparative Example C2 is increasingly substituted by the acrylate of Example 1. Films are prepared and tested as in the prior examples. Formulations and test results are summarized in Table 2.

TABLE 2

| Example: | C2 | 7 | 8 | 9 |
|---|---|---|---|---|
| Formulation | | | | |
| Sartomer ™ | 5 | 5 | 5 | 5 |
| 104C75 | | | | |
| TPGDA | 5 | 4 | 3 | 2 |
| Example 1 | — | 1 | 2 | 3 |
| Acrylate | | | | |
| Test Results | | | | |
| Konig Hardness | 132 | 145 | 146 | 142 |
| Impact | 20/<20 | 20/<20 | 20/<20 | 20/<20 |
| Front/Rev | | | | |
| X-hatch | 0 | 20 | 80 | 100 |
| Adhesion, % | | | | |

In this formulation, substitution of the acrylate of Example 1 for TPGDA results in significant increase in hardness and increasingly favorable adhesion, without significantly altering impact resistance. The increase in hardness is particularly surprising, since the acrylate of Example 1 has a considerably higher molecular weight but the same functionality as TPGDA. One skilled in the art would expect a softer coating under these circumstances.

### EXAMPLES 10-13 and COMPARATIVE EXAMPLE C3

Coatings are prepared as in the prior examples, employing Sartomer® CN 104C75, but the photoinitiator is changed to IRGACURE® 184 at 4% concentration based on total wet coating weight. The coating thickness is 1 mil. The formulations and test results are presented in Table 3 below.

TABLE 3

| Example: | C3 | 10 | 11 | 12 | 13 |
|---|---|---|---|---|---|
| Formulation | | | | | |
| Sartomer ™ | 20 | 20 | 20 | 20 | 10 |
| CN 104C75 | | | | | |
| Acrylate of | — | 4 | 8 | 12 | 10 |
| Example 1 | | | | | |
| TPGDA | 20 | 16 | 12 | 8 | 20 |
| Formulation | 248 | 454 | 790 | 1189 | 155 |
| Viscosity (cps) | | | | | |
| Test Results | | | | | |
| Konig Hardness | 132 | 145 | 146 | 142 | 91 |
| Impact | 20/<20 | 20/<20 | 20/<20 | 20/<20 | 40/<20 |
| Front/Rev | | | | | |
| Crosshatch | 0% | 20% | 80% | 100% | 40% |
| Adhesion | | | | | |
| Tensile | 1650 | 1217 | 2394 | 2408 | 2960 |
| Strength | | | | | |
| Elongation (%) | 0.9 | 1.0 | 2.2 | 3.5 | 6.4 |

In the foregoing examples, hardness improves slightly with increasing amounts of the acrylate of Example 1 being substituted for TPGDA. Impact resistance is retained, while adhesion increases notably. In Examples 11-12, tensile strength increases dramatically, while elongation is superior in all the subject invention examples. Increases in both tensile strength and elongation are unusual for thermoset coatings, particularly when hardness increases at the same time. Replacement of a portion of the epoxy acrylate Sartomer™ CN 104C75 with the acrylate of Example 1 leads to a lower viscosity formulation with yet higher tensile strength and elongation, with some sacrifice in coating hardness and adhesion. Impact resistance is also slightly lower. The results indicate considerable improvement in overall properties plus a much greater flexibility in formulation.

### EXAMPLES 14-16 and COMPARATIVE EXAMPLE C4

Coating formulations are prepared similarly to those of Examples 10-13, but employing Sartomer™ CN 104C75, and the acrylate of Example 3 rather than that of Example 1. The formulations and test results are presented in Table 4.

TABLE 4

| Example: | C4 | 14 | 15 | 16 |
|---|---|---|---|---|
| Formulation | | | | |
| Sartomer ™ | 20 | 20 | 20 | 20 |
| CN 120A75 | | | | |
| Example 3 | 0 | 4 | 8 | 12 |
| Acrylate | | | | |
| TPGDA | 20 | 16 | 12 | 8 |
| Formulation | 175 | 273 | 518 | 880 |
| Viscosity (cps) | | | | |
| Test Results | | | | |
| Konig Hardness | 146 | 125 | 130 | 105 |
| Impact | 40/<20 | 40/<20 | 50/<20 | 50/<20 |
| Front/Rev | | | | |
| Crosshatch | 0% | 0% | 10% | 20% |
| Adhesion, % | | | | |
| Tensile | 3369 | 2923 | 5568 | 5043 |
| Strength | | | | |
| Elongation, % | 1.6 | 2.2 | 4.8 | 6.0 |

The results indicate that addition of the higher functionality acrylate of Example 3 also improves adhesion, but at the sacrifice of some degree of hardness. However, the tensile strength and elongation of the films are both improved dramatically.

### EXAMPLES 17 and 18 and COMPARATIVE EXAMPLES C5-C7

Coatings are prepared employing the acrylates of Examples 1 and 2 and compared to coatings employing other flexibilizer oligomers. The formulations and test results are presented below in Table 5.

TABLE 5

| Example: | C5 | C6 | C7 | 17 | 18 |
|---|---|---|---|---|---|
| Formulation | | | | | |
| Sartomer ™ | 20 | 20 | 20 | 20 | 20 |
| CN 120A75 | | | | | |
| Example 1 | 0 | 0 | 0 | 12 | 0 |
| Acrylate | | | | | |
| Example 2 | 0 | 0 | 0 | 0 | 12 |
| Acrylate | | | | | |
| SR602¹ | 12 | 0 | 0 | 0 | 0 |
| CN972² | 0 | 12 | 0 | 0 | 0 |
| TPGDA | 8 | 8 | 20 | 8 | 8 |
| Viscosity (cps) | 525 | 3852 | 157 | 739 | 880 |
| Test Results | | | | | |
| Konig Hardness | 122 | 81 | 137 | 127 | 115 |
| Impact | 70/<10 | 90/<10 | 30/<10 | 80/30 | 80/10 |
| Front/Rev | | | | | |
| Crosshatch | 0% | 0% | 0% | 100% | 80% |
| Adhesion | | | | | |
| 20% Nitric | DC³ | DC | BL, DC | DC | DC |
| Acid, 24 Hr | | | | | |

¹A 10 mole oxyethylated bisphenol A
²An ether urethane
³DC = Discolor, BL = Blister

Employing other commercial flexibilizers in place of the subject invention acrylates does not increase adhesion, impact resistance, or chemical resistance.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention. In the claims, the terms “a” and “an” mean “one or more than one” unless clearly indicated to the contrary.

What is claimed is:

1. An (meth)acrylate-functional composition comprising an (meth)acrylate ester of an oxyalkylated, aralkylated multi-ring phenolic polyol prepared by the process of:
a) selecting a multi-ring aralkylated phenolic starter having minimally two phenolic hydroxyl groups and at least three aryl ring systems which are not condensed with each other;
b) oxyalkylating said aralkylated phenolic starter with from 0.5 to 10 mol of oxyalkylating agent per equivalent of phenolic hydroxyl groups to produce an oxyalkylated aralkylated phenolic intermediate;
c) esterifying said oxyalkylated aralkylated phenolic intermediate with an alkacrylic acid or esterifyable derivative thereof to produce said (meth)acrylate ester of said oxyalkylated alkarylated multi-ring phenolic polyol,
wherein said step of esterifying is conducted with sufficient alkacrylic acid or esterifyable derivative thereof such that 70 mol percent or more of total hydroxyl groups are esterified.

2. The composition of claim 1, wherein 80 mol percent or more of hydroxyl groups are esterified.

3. The composition of claim 1, wherein about 90 mol percent or more of hydroxyl groups are esterified.

4. The composition of claim 1, wherein said aralkylated multi-ring phenolic starter comprises a styrenated phenolic compound.

5. The composition of claim 1, wherein said aralkylated multi-ring phenolic starter has a phenolic hydroxyl functionality which averages between 2 and 10.

6. The composition of claim 1, wherein said aralkylated multi-ring phenolic starter has a phenolic hydroxyl functionality which averages between 2and 5.

7. The composition of claim 1, wherein at least one of said oxyalkylating agent(s) is selected from the group consisting of ethylene carbonate, propylene carbonate, ethylene oxide, propylene oxide, 1,2-butylene oxide, 2,3-butylene oxide, and styrene oxide.

8. The composition of claim 1, wherein said oxyalkylating agent comprises propylene oxide.

9. The composition of claim 1 wherein said aralkylated multi-ring phenolic polyol comprises formaldehyde-coupled aralkylated bisphenol A.

10. The composition of claim 1, wherein said alkacrylic acid comprises acrylic acid.

11. A low viscosity acrylate-functional compound,
said compound comprising an acrylate ester of an oxyalkylated multi-ring aralkylated phenol having at least three non-condensed aromatic rings, at least one of said non-condensed aromatic rings comprising a phenolic hydroxyl-group free aryl group linked to a phenolic hydroxyl-group-containing aryl group through an alkylene bridge, said alkylene bridge optionally interrupted by one or more of an aryl group, O, and N;
said multiring aralkylated phenol having, prior to oxyalkylation to form said oxyalkylated multi-ring aralkylated phenol, from
2 to 10 phenolic hydroxyl groups;
said oxyakylation sufficient to provide, on average, from 2 to 25 mol of oxyalkylene groups per mol of phenolic hydroxyl groups;
said oxyalkylated multi-ring aralkylated phenol having less than 20 mol percent free phenolic hydroxyl groups based on the total mol of phenolic groups initially present in said multi-ring aralkylated phenol; and
said acrylate-functional compound being a liquid with a neat viscosity less than 3000 cps at 25° C.

12. The acrylate-functional compound of claim 11, wherein said multi-ring aralkylated phenol comprises a reaction product of a bisphenol, an optionally substituted styrene, and optionally, formaldehyde or an aryldiolefin.

13. The acrylate-functional compound of claim 12 which has an acrylate functionality of from 2 to 4, wherein said oxyalkylation is performed with propylene oxide to an average degree of oxyalkylation of from 3 to 15, and wherein the viscosity of said acrylate-functional is less than 1500 cps at 25° C.

14. An addition-curable composition comprising at least one (meth)acrylate-functional composition of claim 1 and a catalyst which promotes the addition polymerization of ethylenically-unsaturated compounds.

15. The addition-curable composition of claim 14, wherein said catalyst comprises a photoinitiator.

16. The composition of claim 14, wherein said composition further comprises a (meth)acrylate-functional monomer other than said (meth)acrylate-functional composition.

17. The composition of claim 14, further comprising at least one (meth)acrylate selected from the group consisting of the (meth)acrylates of C₂₋₁₀ aliphatic glycols, trimethylolpropane tri(meth)acrylate, and glycerine tri(meth)acrylate.

18. A process for increasing the adhesion and/or hardness of a cured, addition-curable composition derived from (meth)acrylate-functional components, said process comprising adding at least one (meth)acrylate-functional composition of claim 1 to said addition-curable composition prior to cure.

19. The process of claim 18, wherein one of said (meth)acrylate-functional components is replaced all or in part by said (meth)acrylate-functional composition.

20. The process of claim 18, wherein one of said (meth)acrylate-functional components comprises a (meth)acrylate-functional epoxy resin.
